(19) United States
(12) Patent Application Publication
(10) Pub. No.: US 2019/0352494 A1
(43) Pub. Date: Nov. 21, 2019

(54) Free-Flowing Play Gel Composition and Activator Thereof

(71) Applicant: LAROSE INDUSTRIES, LLC, Randolph, NJ (US)

(72) Inventors: Lawrence Rosen, Mendham, NJ (US); Daniel Khakshoor, Great Neck, NY (US)

(73) Assignee: LAROSE INDUSTRIES, LLC, Randolph, NJ (US)

(21) Appl. No.: 16/363,490

(22) Filed: Mar. 25, 2019

Related U.S. Application Data
(60) Provisional application No. 62/672,948, filed on May 17, 2018.

(51) Int. Cl. C08L 29/04; C08K 5/053; C08K 5/17; C08K 5/098; C08K 5/205; C08K 5/32

(52) U.S. Cl. CPC C08L 29/04; C08K 5/053; C08K 5/17; C08L 3/02; C08K 5/205; C08K 5/32; C08K 5/098

(57) ABSTRACT

An activator formulation is disclosed for use in making an entertaining slime product. The activator includes water, a glycerol and/or a glycol, triethanolamine and a preservative. Glycols such as propylene glycol are suitable, while glycerols such as glycerin are appropriate. When added to a mixture of water and glue and then manually manipulated, an amusing play gel can be formed safely and quickly.

### CROSS-REFERENCE TO RELATED APPLICATION

This application claims priority to U.S. Provisional Patent Application Ser. No 62/672,948 filed May 17, 2018, the entire disclosure of which is incorporated herein by reference.

### FIELD OF THE INVENTION

The present invention pertains to toy free-flowing play gels and the like typically enjoyed by children. In particular, it belongs to the subset of gels of a viscous sort that can be stretched and kneaded to make a variety of different and amusing shapes.

### BACKGROUND OF THE INVENTION

The prior art is replete with examples of putty-like, gel-like, or paste-like products designed to be manually manipulated for fun and amusement by children or other end users. For example, U.S. Pat. Nos. 8,476,343 and 9,617,403 relate to toy putty compositions formed from a homogeneous mixture of water, polyvinyl alcohol, gum, and borax (a/k/a sodium borate, sodium tetraborate, or disodium tetraborate).

The use of borax is disadvantageous for many reasons. For example, due to its typical powdery form, the aforesaid mixture results in a solution that is not as smooth as one made entirely from liquids. If not properly used, borax could cause burns and blisters on the skin of a user. Also, because borax is relatively toxic, it can be harmful if ingested through the nose or mouth of a user, who would typically be a child.

### SUMMARY OF THE INVENTION

A compound for use as a novel and safe play gel, or slime, includes water; a chemical selected from the group of categories consisting of glycols and glycerols; triethanolamine; a preservative; and a glue. The play gel can be made in accordance with a quick and easy manual method by, for example, mixing water and glue to form a first mixture; adding a chemical activator, which includes triethanolamine, to the first mixture to create a second mixture; manipulating the second mixture; and allowing the second mixture to gel.

The aforementioned chemical activator can be in the form of a compound which, for example, includes water; a chemical selected from the group of categories consisting of glycols and glycerols; triethanolamine; and a preservative. In one embodiment, the preservative includes iodopropynyi butylcarbamate. In another embodiment, the preservative includes potassium sorbate and sodium benzoate. Both of these preservative embodiments have no paraben content; and therefore, they contribute to the overall safety of the final gel product.

### DETAILED DESCRIPTION OF THE EXEMPLARY EMBODIMENTS

The unique composition which forms the free-flowing play gel of the present invention involves a new and improved activator formulation which is used in combination with any of the suitable glues described below to form the desired end product, namely a slimy, stretchable, non-tacky, rubbery material suitable for use as a toy or plaything by children and adults alike. In an embodiment, the aforesaid activator formulation includes the following four components: (1) water; (2) propylene glycol; (3) tri ethanol amine (e.g., triethanolamine 99%); and (4) a preservative, such as Microcare® DMP. What follows is a more detailed description of each of the four components identified above.

The water component is typically standard tap water, but it could be distilled water. In an embodiment, the weight percentage of the water is in a range of from about 50% to about 80% by weight. In another embodiment, the weight percentage of the water is in a range of from about 50% to about 60% by weight. In another embodiment, the weight percentage of the water is in a range of from about 60% to about 70% by weight. In another embodiment, the weight percentage of the water is in a range of from about 70% to about 80% by weight. In another embodiment, the weight percentage of the water is in a range of from about 50% to about 70% by weight. In another embodiment, the weight percentage of the water is in a range of from about 60% to about 80% by weight. In another embodiment, the weight percentage of the water is in a range of from 0% to about 99% by weight. While water is not a required component of the new and improved activator formulation, it is a desirable component as it thins and dilutes the resulting activator, thereby diluting its active ingredients and producing an end product which is comparatively safe if inadvertently ingested by a user.

The propylene glycol component (also known as 1,2 propanediol or methyl ethyl glycol) acts as a liquid antifreeze, humectant (i.e., a moisture retainer or preserver), and a plasticizer lubricant. The propylene glycol component is USP grade. The propylene glycol also enhances the stretchability of the glue that the activator is mixed with, providing lubricity and flexibility as well. In an embodiment, the weight percentage of the propylene glycol is in a range of from about 1% to about 20% by weight. In another embodiment, the weight percentage of the propylene glycol is in a range of from about 1% to about 3% by weight. In another embodiment, the weight percentage of the propylene glycol is in a range of from about 1% to about 5% by weight. In another embodiment, the weight percentage of the propylene glycol is in a range of from about 1% to about 10% by weight. In another embodiment, the weight percentage of the propylene glycol is in a range of from about 1% to about 15% by weight. In another embodiment, the weight percentage of the propylene glycol is in a range of from about 5% to about 20% by weight. In another embodiment, the weight percentage of the propylene glycol is in a range of from about 5% to about 15% by weight. In another embodiment, the weight percentage of the propylene glycol is in a range of from about 5% to about 10% by weight. In another embodiment, the weight percentage of the propylene glycol is in a range of from about 10% to about 15% by weight. In another embodiment, the weight percentage of the propylene glycol is in a range of from about 10% to about 20% by weight. In another embodiment, the weight percentage of the propylene glycol is in a range of from about 15% to about 20% by weight. Other glycols or glycerols (e.g., glycerin) can be substituted for propylene glycol while adhering to the aforementioned parameters. Although the use of glycerin, especially if used excessively, can make the end product very stretchable, it might also make the end product too sticky or tacky. A suitable propylene glycol can be purchased from Pride Chemical Solutions, Inc. of New Jersey/New York or, alternately, Inland Technologies International Ltd., 14 Queen Street, Truro, NS B2N 5C1 Canada, as product identifier CAS No. 57-55-6.

The triethanolamine component is an alkaline base liquid (having a pH of at least 9.0, but in embodiments anywhere in a pH range of from about 9.0 to about 10.0) with the capability of reacting with the acidic glue (e.g., having a pH of about 4.6 to 4.8) that the activator is mixed with. In an embodiment, the weight percentage of the aforementioned triethanolamine is in a range of from about 0.05% to about 100% by weight. In another embodiment, the weight percentage of the triethanolamine is in a range of from about 2% to about 20%. In another embodiment, the weight percentage of the triethanolamine is in a range of from about 2% to about 5%. In another embodiment, the weight percentage of the triethanolamine is in a range of from about 2% to about 10%. In another embodiment, the weight percentage of the triethanolamine is in a range of from about 2% to about 15%. In another embodiment, the weight percentage of the triethanolamine is in a range of from about 5% to about 10%. In another embodiment, the weight percentage of the triethanolamine is in a range of from about 5% to about 15%. In another embodiment, the weight percentage of the triethanolamine is in a range of from about 5% to about 20%. In another embodiment, the weight percentage of the triethanolamine is in a range of from about 10% to about 15%. In another embodiment, the weight percentage of the triethanolamine is in a range of from about 10% to about 20%. The triethanolamine is the active ingredient of the new and improved activator formulation disclosed herein as it reacts instantly with the glue and gels up the glue after only a few minutes of mixing to produce a slimy, stretchable, non-tacky, rubbery material. Preferably, the grade of triethanolamine includes a grade exceeding 99% pure, but can include other grades, such as 88% pure and higher. A suitable triethanolamine can be purchased from Huntsman International LLC, P.O. Box 4980, The Woodlands, Tex. 77387, as product identifier CAS No. 102-71-6. Other amines may be utilized, provided they are cosmetic grade and otherwise as safe as triethanolamine.

A number of preservatives can serve a similar function. In an embodiment, the preservative is the product commercially available under the trademark ACTICIDE® LPN5 manufactured by Thor Specialties, Inc., 50 Waterview Drive, Shelton, Conn. 06484, the product containing sodium benzoate and potassium sorbate, but no paraben.

In another embodiment, the preservative is the product commercially available under the trademark ACTICIDE® IPS20 manufactured by Thor Specialties, Inc., 50 Waterview Drive, Shelton, Conn. 06484, the product containing 20% iodopropynyl butylcarbamate, but no paraben.

In a further embodiment, the preservative is the product commercially available under the trademark Microcare® DMP, which product includes water, propylene glycol, diazolidinyl urea, methylparaben, and propylparaben. More specifically, the Microcare® DMP product is a liquid commonly used in the cosmetic industry and manufactured by Thor Specialties, Inc., 50 Waterview Drive, Shelton, Conn. 06484, as Product No. M 5011, which is equivalent to a preservative manufactured by Ashland, P.O. Box 2219,Columbus, Ohio, 43216 and marketed under the product name Germaben® II.

Alternate preservative useful in practicing the present invention include bronopol, also made by Thor Specialties, as well as any other suitable preservative known in the art having a clear color (i.e., not yellow in color) capable of producing a clear activator solution. Because the activator solution is water-based, it is susceptible to the growth of mold if left stagnant for a couple of days or longer. The preservative component therefore keeps the activator solution, and hence the end product, free from mold and/or fungus. The preservative component of the activator solution also functions to keep the end product free from mold and dirt when children or other end users play with it using dirty hands, thereby preserving the clean appearance of the end product. Other preservatives may be used, bearing in mind the need to comply with local, federal and any applicable safety standards.

The preferable weight percentage of the preservative component is in a range of from about 0.05% to about 3%. In another embodiment, the weight percentage of the preservative component is in a range of from about 0.05% to about 2%. In another embodiment, the weight percentage of the preservative component is in a range of from about 0.05% to about 1.5%. In another embodiment, the weight percentage of the preservative component is in a range of from about 0.05% to about 1%. In another embodiment, the weight percentage of the preservative component is in a range of from about 0.05% to about 0.5%. In another embodiment, the weight percentage of the preservative component is in a range of from about 1% to about 2%. In another embodiment, the weight percentage of the preservative component is in a range of from about 1% to about 3%. In another embodiment, the weight percentage of the preservative component is in a range of from about 2% to about 3%. The weight percentage of the preservative component is relatively low compared to the other components of the new and improved activator formulation, because the inclusion of a preservative, while not required, is advantageous for the reasons discussed above.

Every ingredient that goes into the activator is in a liquid state, thereby simplifying its preparation and rendering it suitable for storage in plastic bottles as part of a kit. In an embodiment, the activator ingredients are mixed together in a standard spin drum, at room temperature with no heat or pressure. The order in which the ingredients are added does not affect the efficacy or composition of the activator solution produced thereby. However, environmental temperatures exceeding 75° F. should be avoided as the heat may kill and negate the preservative component of the activator solution. While many uses do not require the addition of a colorant, any standard paint colorant or food colorant known in the art may be added to the activator, typically at a weight percentage less than 1%.

The activator solution may be used in combination with specialized glue products supplied as part of a custom kit along with the activator solution. Two specialized glue embodiments will be discussed below.

In one embodiment, the specialized glue is a clear glue, which contains polyvinyl alcohol. The clear glue may also include solids in a range of from about 14% to about 16% by weight, or alternatively in a range of from about 12% to about 18% by weight. The clear glue is acidic, with a pH typically around 4.6 to 4.8. In an embodiment, the glue's viscosity is in a range of from about 5,000 centipoise to about 5,500 centipoise, or alternatively in a range of from about 2,000 centipoise to about 10,000 centipoise, thereby enabling the clear glue to flow freely from its bottle or other container. In use, the acidic glue reacts with the alkaline activator of the present invention to thereby counteract the glue's acidity, whereby a neutral, or almost neutral, pH in a range from about 7.0 to 8.0 is achieved. A suitable clear glue may be purchased from Baker Adhesive, Patterson, N.J.; IFS; or Modern Blending Technologies, Inc.

In another embodiment, the specialized glue is a white glue, which contains polyvinyl acetate and starch, and optionally polyvinyl alcohol. In an embodiment, the white glue's viscosity is in a range of from about 6,000 centipoise to about 8,000 centipoise. Like the glue described above, the white glue is acidic, with a pH typically around 4.6. The acidic white glue therefore reacts with the alkaline activator of the present invention in the same manner as the clear glue described above.

The desired end product can be produced and customized by a child or other end user who implements a process that involves the following manual steps, regardless of which of the above-described specialized glues is employed:

Step 1: Measure and pour 15 ml of glue into a bowl at room temperature.

Step 2: Measure and add 20-25 ml of room temperature tap water to the bowl if the specialized clear glue is used in Step 1; alternatively, 30 ml of water may be added, if the specialized white glue is used in Step 1.

Step 3: Add any desired glitter, gems or colorants, assuming such optional additives are provided in the kit supplied to the user. This step may be performed before Step 2, but should precede Step 4; otherwise, these items will be difficult to add.

Step 4: Measure 5 ml of activator and slowly add it to the bowl while simultaneously mixing with a mixing stick provided with the aforementioned kit. As described above, the activator functions to neutralize the glue's acidity thereby producing a neutral, or almost neutral, pH in a range of from about 7.0 to about 8.0.

Step 5: Remove the bowl's contents by hand while kneading, stretching and pulling it.

Step 6: Once the mixture gels, which should occur instantly, wait 1 to 2 minutes for the end product to form.

The new and improved activator of the present invention employs an active ingredient (e.g., triethanolamine) that is commonly used in cosmetic products, soaps and paints (as a thickener) and one that is therefore safer than the known activators used to make the end products of the prior art. Because the aforesaid triethanolamine component is a liquid rather than a powder, the resulting activator solution is smoother in manufacture and use than known activators employing a powdery component.

The end product made from the new and improved activator is odorless and does not irritate the skin of a user. Because the activator of the present invention is colorless, the end product is subject to customization by a user, who has the option of adding colorants to produce an end product of any desired color.

The method of manufacturing the end product of the present invention is faster than known methods of manufacturing the end products of the prior art. The manufacturing method disclosed herein also results in an end product that is ready for use almost immediately. The resulting end product also exhibits good stretchability and flexibility, while providing a rubbery feel due to the neutralization of the glue's tackiness by the new and improved activator of the present invention.

It will be understood that the embodiments described herein are merely exemplary and that a person skilled in the art may make many variations and modifications without departing from the spirit and scope of the present invention. All such variations and modifications are intended to be included within the scope of the present invention as defined in the appended claims.

1. (canceled)

2. The free-flowing play gel product of claim 19, wherein said chemical is propylene glycol.

3. The free-flowing play gel product of claim 19, wherein said chemical is glycerin.

4. The free-flowing play gel product of claim 19, wherein said triethanolamine is at least about 88% pure.

5. The free-flowing play gel product of claim 19, wherein said preservative comprises sodium benzoate and potassium sorbate.

6. The free-flowing play gel product of claim 19, wherein said preservative comprises 20% iodopropynyl butylcarbamate.

7. The free-flowing play gel product of claim 19, wherein said preservative comprises bronopol.

8. The free-flowing play gel product of claim 19, further comprising a colorant.

9-11. (canceled)

12. The free-flowing play gel product of claim 19, further comprising at least one decorative element.

13. (canceled)

14. The free-flowing play gel product of claim 20, wherein said clear acidic glue further comprises solids in a range of from about 12% weight to about 18% weight.

15. The free-flowing play gel product of claim 20, wherein said clear acidic glue has a viscosity in a range of from about 2,000 centipoise to about 10,000 centipoise.

16. The free-flowing play gel product of claim 19, wherein said acidic glue is a white acidic glue comprising polyvinyl acetate.

17. The free-flowing play gel product of claim 16, wherein said white acidic glue has a viscosity in a range of from about 6,000 centipoise to about 8,000 centipoise.

18. The free-flowing play gel product of claim 19, wherein said acidic glue has a pH of of at least about 4.6.

19. A free-flowing play gel product adapted to be manually manipulated for fun and amusement by children and other end users, comprising:
water;
acidic glue;
a chemical selected from the group of categories consisting of glycols and glycerols;
an alkaline liquid base; and
a preservative.

20. The free-flowing play gel product of claim 19, wherein said acidic glue is a clear acidic glue comprising polyvinyl alcohol.

21. The free-flowing play gel product of claim 19, wherein said chemical and said preservative are in liquid form.

22. The free-flowing play gel product of claim 16, wherein said white acidic glue further comprises starch.

23. The free-flowing play gel product of claim 16, wherein said white acidic glue further comprises polyvinyl alcohol.

24. The free-flowing play gel product of claim 19, wherein said alkaline base liquid is triethanolamine having a pH in a range of from about 9 to about 10.

25. The free-flowing play gel product of claim 19, wherein said product has a pH in a range of from about 7 to about 8.
